(19) United States
(12) Patent Application Publication
(10) Pub. No.: US 2004/0179717 A1
(43) Pub. Date: Sep. 16, 2004

(54) Printing system, method of inspecting print data, method of classifying print inspection result and program

(75) Inventors: Itaru Furukawa, Kyoto (JP); Takashi Mouri, Kyoto (JP); Souichi Kimura, Kyoto (JP); Masayuki Fukase, Kyoto (JP)

Correspondence Address: MCDERMOTT, WILL & EMERY, 600 13th Street, N.W., WASHINGTON, DC, 20005-3096, US

(73) Assignee: DAINIPPON SCREEN MFG. CO., LTD.

(21) Appl. No.: 10/756,467

(22) Filed: Jan. 14, 2004

(30) Foreign Application Priority Data
Mar. 12, 2003 (JP) P2003-066795
Mar. 26, 2003 (JP) P2003-085639

(51) Int. Cl. G06K 9/00

(52) U.S. Cl. 382/112

(57) ABSTRACT

In an RIP processing apparatus, layout information of each of objects arranged in original data is obtained to generate initial attribute information. In a print inspection apparatus, the initial attribute information is transformed in accordance with an inspection object image to generate attribute information and a print inspection parameter reflecting the attribute information is set. In performing a print inspection, an area in object image data which is intended for the print inspection is specified by the attribute of image element. With this operation, even when image areas of different attributes are mixed, an optimum print inspection for each image area can be performed and it is therefore possible to efficiently obtain a significant inspection result by one operation on the whole of object image data. Further, after the print inspection, the inspection result is automatically classified into a predetermined category on the basis of a shape of a differential area which is caused by the print inspection, a type (image feature) of area where the differential area is present, a comparison method causing the differential area, or the like. This eliminates necessity of operator's visual check, thereby remarkably improving operation efficiency. Furthermore, since a classification result is stored in a database, extraction and analysis of a specific tendency found in the print inspection result becomes easier and when an unexpected inspection result is obtained, early solution of the cause thereof can be made. Thus provided is a printing system which is capable of performing a print inspection under different conditions for image areas having different features in image data to be inspected and automatically classifying a print inspection result in accordance with its content.

### BACKGROUND OF THE INVENTION

1. Field of the Invention

The present invention relates to an inspection for printing (or print data) in a printing work flow, and more particularly to an inspection of digital print data.

2. Description of the Background Art

Inspection for printing generally refers to an operation which is performed before generation of a plate-making film and a printing plate in a printing work flow, to check if there are any error in a camera-ready art, a film or the like which are respective original bases of the printing plate, the plate-making film, or the like. Recently, with progress of DTP (desktop publishing) technique, an apparatus has been well-known which performs an inspection of digital print data, together with color proof, by comparing print data of the first proof and that of the revised proof with each other, both of which are processed (rasterized) by an RIP (raster image processor), by pixel on a display screen to detect a differential value of color density (tone value) of each pixel. Since a CTP (Computer To Plate) process for direct plate making from the print data which is processed by the RIP and a digital printing for directly producing a printed matter have become general work flows in these days, the inspection of digital print data becomes increasingly important.

In general, the print data mixedly contains a “character area”, a “picture area”, a “tint/gradation area” and the like, and these areas have different image feature values, specifically, features in value extractable by image processing, such as “edge component”, “tone level of each plate”, “lightness” and “hue” contained in images constituting the print data. Further, there is difference in human's visual property to sense these areas, in other words, detection sensitivity (acuity) to difference. A print inspection operation often has a case, for example, where in a character area, a difference in tint of edge is negligible and there arises little problem if it is admitted while in a picture area having gentle gradation, even slight difference in tint is noticeable and strict uniformity in color density is required.

Therefore, for more effective inspection for printing, it is preferable that a print inspection operation should be performed under a processing condition in accordance with features of each area and an obtained result should be judged by a criterion of each area.

A digital-data inspection apparatus which performs an inspection of print data mixedly containing character areas, picture areas and the like by identifying the picture areas is disclosed, e.g., in Japanese Patent Application Laid Open Gazette No. 2003-8868.

The digital-data inspection apparatus of Japanese Patent Application Laid Open Gazette No. 2003-8868, however, can judge whether a picture area or not but no technique for identifying a character area or a tint/gradation area is disclosed. Neither technique to perform a print inspection operation under different conditions by areas is disclosed. In other words, the digital-data inspection apparatus of Japanese Patent Application Laid Open Gazette No. 2003-8868 disadvantageously processes a character area, a picture area, a tint/gradation area and the like, which are greatly different from one another in image feature, under the same processing condition and therefore can not obtain an effective result of print inspection. Alternatively, the apparatus needs repeating executions of print inspection on one print data under different processing conditions and comprehensive judgment on obtained results, and that is very inefficient.

Further, the digital-data inspection apparatus of Japanese Patent Application Laid Open Gazette No. 2003-8868 performs judgment of areas only on data after rasterization processing and no judgment on a plate image which is formed on a printing plate or a printed matter which is outputted. Therefore, the apparatus can not identify an area in print inspection for these things.

In a case of inspection of digital printing data, because of an operation on a terminal of a computer or the like, the operation can be performed more efficiently at lower cost but takes longer time since errors are harder to find and careful check is needed, as compared with a conventional visual inspection through visual check of a printed matter which is revised. On the other hand, plate making companies and printing companies or makers of plate making or printing system, which need to inspect a large number of data in their jobs, make a strong request of increase in efficiency of the print inspection operation. In order to meet such a request, a technique to increase efficiency of a digital-data inspection operation is disclosed in, e.g., Japanese Patent Application Laid Open Gazette No. 2000-29198.

In an inspection of digital printing data, when there is some difference between image data (object image data) of a print image (object image) to be inspected and image data (reference image data) of a print image (reference image) serving as a reference for inspection, regardless of whether the difference is intended by an operator or not, differential data representing the difference is outputted. In a case where the object image data which is obtained by operator's addition of some change such as font change to the reference image data is inspected, it can be judged from the differential data whether only the change is correctly outputted as difference or there arises any difference at a portion without any change.

The difference which is outputted as the differential data has some possible patterns. In a case of printed matter including three areas, i.e., a picture area, a character area and a tint area, for example, the status for occurrence of the difference corresponds to one of the following eight patterns:

1) only “picture”

2) only “character”

3) only “tint”

4) “picture” and “character”

5) “picture” and “tint”

6) “character” and “tint”

7) all of “picture”, “character” and “tint”

8) no difference in all the areas.

In the background-art digital-data inspection operation, when there is some difference, it is necessary to perform a check one by one on which pattern the difference between the object image data and the reference image data, which is represented by the differential data, corresponds to, e.g., on display or by a printed matter. When a large number of print inspection operations are performed in series, it is necessary to perform this check on all the differential data in order to recognize the status for occurrence of difference and this is a factor of inhibiting increase in efficiency of the print inspection operation.

### SUMMARY OF THE INVENTION

The present invention is intended for a print inspection operation in a printing system, more particularly for a print inspection apparatus for inspecting digital printing data and its relevant technique.

According to the present invention, a printing system comprises a) a rasterization processing apparatus which comprises a-1) a rasterization processing element for performing a rasterization processing of layout data to generate output image data, and a-2) an attribute information generation element for generating first attribute information containing an attribute and layout information of an object which is a constituent of the layout data, and the printing system also comprises b) a print inspection apparatus which comprises b-1) a comparison element for comparing inspection object data with reference data to perform a print inspection, the inspection object data being the output image data or image data acquired in a processing on the basis of the output image data and the reference data representing an image as a reference for comparison with the inspection object data, and b-2) an attribute information processing element for generating second attribute information on the basis of the first attribute information, the second attribute information being information on an attribute and layout information of an image element which is a constituent of the inspection object data or the reference data, and in the printing system of the present invention, the print inspection apparatus performs the print inspection selectively for each area with one attribute of the image element in the inspection object data or the reference data.

Since the type of constituent element of a print image and the exact layout position thereof can be thereby obtained in a rasterization processing of an ante-stage printing work flow, the print inspection can be performed only on an area formed of image elements of the same attribute. Therefore, it is possible to perform the print inspection with efficiency and improve the operation efficiency as classification of an area where the difference is caused by the inspection and analysis on the inspection result on the basis of the classification can be easily performed.

Preferably, the attribute information processing element comprises b-2-1) a coordinate transformation element for transforming a coordinate value of the first attribute information into a coordinate value suitable for the inspection object data, to generate the second attribute information.

Since the attribute information obtained in arrangement of the layout data is thereby transformed into information suitable for the inspection object data, the print inspection can be performed on image data having resolution and size different from those of the layout data by using the attribute information.

According to another aspect of the present invention, a printing system which generates print image data and performs at least one of plate making and output on the basis of the print image data, comprises a print inspection apparatus which comprises a) a comparison element for comparing inspection object data with reference data to perform a print inspection, the inspection object data acquired in a processing of print image data and the reference data representing an image condition as a reference for comparison with the inspection object data, b) a feature extraction element for extracting a feature of a print inspection result and c) a classification element for classifying the print inspection result on the basis of the feature.

It is thereby possible to classify and organize the print inspection result without operator's visual check of the inspection result. In a case of inspection of many images, the operation efficiency can be dramatically improved.

Preferably, the feature extraction element comprises at least one of b-1) a differential image feature extraction element for extracting a feature of a differential area appearing in a differential image which is represented by differential image data obtained as the print inspection result, b-2) a reference image feature extraction element for extracting an image feature of an area in the reference data corresponding to the differential area and b-3) a setting dependence feature extraction element for extracting a feature of the print inspection result which depends on setting of a processing condition in the print inspection.

In this case, by providing the differential image feature extraction element, it is possible to classify and organize the print inspection result in accordance with the feature found in the differential image without operator's visual check of the differential image obtained as the inspection result. By providing the reference image feature extraction element, it is possible to determine an image feature of the area in the reference image where the differential area found in the differential image is present without operator's one-by-one comparison between the differential image obtained as the print inspection result and the reference image used for inspection and possible to classify and organize the inspection result on the basis of a content of the image. Further, by providing the setting dependence feature extraction element, since the print inspection result can be classified and organized, being associated with a processing condition when the print inspection is performed with the processing condition changed, it is possible to more appropriately classify and organize the print inspection (result), taking the pixel displacement and variation in density into consideration.

It is a first object of the present invention to provide a printing system which is capable of acquiring the type and an exact layout position of a constituent element of image data to be inspected in each stage of a work flow and performing a print inspection operation under different conditions for image areas of different features on the basis of those acquired information, and its relevant technique.

It is a second object of the present invention to provide a print inspection apparatus for automatically classifying a print inspection result in accordance with its content and a printing system comprising the same.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a constitution of a printing system including a print inspection apparatus in accordance with a first preferred embodiment;

FIG. 2 is a view showing functions implemented in a control part of an RIP processing apparatus;

FIG. 3 is a view showing functions implemented in a control part of the print inspection apparatus;

FIG. 4 is a flowchart showing operation flow of attribute analysis in the RIP processing apparatus;

FIG. 5 is a view illustrating original data;

FIG. 6 is a view illustrating part of contents of the original data which is described e.g., in PDF;

FIG. 7 is a flowchart showing operation flow of the print inspection apparatus;

FIG. 8 shows a parameter table as an example of setting of tone margin values and isolated point removal values in a judgment parameter;

FIG. 9 is a view showing a case of generating initial attribute information in accordance with a variation of the first preferred embodiment;

FIG. 10 is a schematic diagram illustrating a constitution of a printing system including a print inspection apparatus in accordance with a second preferred embodiment;

FIG. 11 is a view showing functions inplemented in a control part of the print inspection apparatus;

FIG. 12 is a flowchart showing operation flow in the print inspection apparatus;

FIGS. 13A to 13C are views showing an example of swing (shift) operation;

FIGS. 14A to 14D are exemplary settings of tone margin;

FIG. 15 is a flowchart showing operation flow for generating differential image feature data;

FIG. 16 is a flowchart showing operation flow for generating reference image feature data; and

FIGS. 17A to 17F, 18A to 18F and 19A to 19F are views showing generation of the reference image feature data.

### DESCRIPTION OF THE PREFERRED EMBODIMENTS

<The First Preferred Embodiment>

<System Configuration>

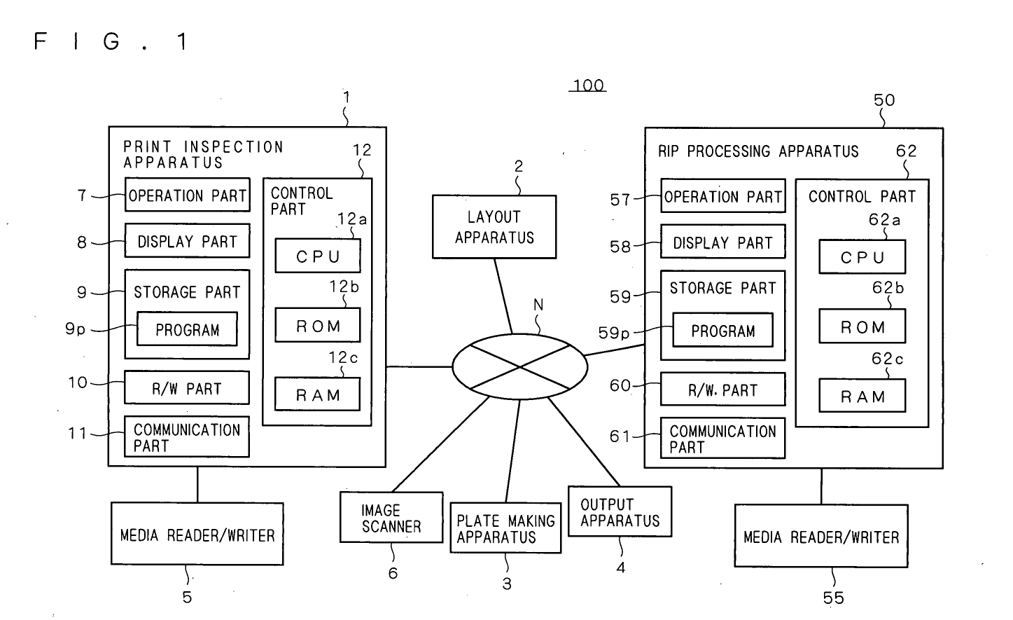

FIG. 1 is a schematic diagram illustrating a constitution of a printing system 100 including a print inspection apparatus 1 in accordance with the first preferred embodiment of the present invention. The printing system 100 mainly comprises the print inspection apparatus 1, a layout apparatus 2, a plate making apparatus 3, an output apparatus 4 and an RIP processing apparatus 50, where these apparatus are electrically connected with one another via a network N such as LAN (Local Area Network), to perform a printing work flow consisting of generation of print data, plate making, and output.

The print inspection apparatus 1 extracts whether or not there is any difference between an object image to be inspected and a reference image by comparison in order to check if instructions for correction are rightly reflected in the revised data, if there is any unexpected difference between the revised data, a printing plate or an actually-outputted printed matter and original data, or the like.

The layout apparatus 2 performs layout such as typesetting and image layout in a print image. Layout data is described in a page description language (PDL) such as PDF (Portable Document Format).

The RIP processing apparatus 50 receives the layout data (original data) via the network N and performs an RIP processing (rasterization processing) of the layout data to generate multitone image data. Further, the RIP processing apparatus 50 is capable of generating image data of various resolutions depending on the use from one layout data. For example, there is a possible case where multitone image data of coarse resolution, e.g., about 400 dpi is generated for inspection and high resolution halftone image data of 2400 dpi is generated for output.

The layout apparatus 2 and the RIP processing apparatus 50 may be provided separately (independently from each other) or may be provided as a unit. Alternatively, there may be a case where the print inspection apparatus 1 comprises the RIP processing apparatus 50 and performs an RIP processing of the layout data, followed by a print inspection.

The plate making apparatus 3 is a so-called CTP apparatus, which makes a printing plate, on the basis of halftone image data, for example, by generating a print image on a plate (printing material) by laser exposure. Further, there may be a case where a plate-making film is once generated by an image setter on the basis of the halftone image data and then the printing plate is made by using the plate-making film. In this case, the plate making apparatus 3 includes the image setter.

The output apparatus 4 performs printing on printing paper by using the printing plate made by the plate making apparatus 3. Alternatively, the output apparatus 4 may perform a digital output, that is, a direct printing from the halftone image data onto the printing paper.

Instead of receiving the layout data (original data) via the network N, the RIP processing apparatus 50 may comprise a media reader/writer 55 such as an MO drive or a CD-R/RW drive and read the layout data which is once stored in various portable recording media such as MO (magneto-optic disk) or CD-R/RW to perform the RIP processing of this data. The image data after the RIP processing is subjected to a post-stage work flow such as an inspection for printing. Further, the RIP processing apparatus 50 may have the function of the layout apparatus 2. Alternatively, there may be a case where the print inspection apparatus 1 has the function of the RIP processing apparatus 50 and performs the RIP processing of the layout data, followed by the print inspection.

The print inspection apparatus 1 may have a function of, e.g., receiving the image data (output image data) after the RIP processing by the RIP processing apparatus 50 via the network N to perform an inspection of the data. Alternatively, the print inspection apparatus 1 may comprise a media reader/writer 5 such as an MO drive or a CD-R/RW drive and read the image data which is once stored in various portable recording media such as MO (magneto-optic disk) or CD-R/RW to perform an inspection of this data.

If an image scanner 6 is connected to the network N, there may be a case where the image scanner 6 scans the printing plate, the plate-making film or the printed matter outputted from the output apparatus 4 to directly acquire the image data and the image data is subjected to the inspection.

Both the print inspection apparatus 1 and the RIP processing apparatus 50 are actualized by a computer. Specifically, the print inspection apparatus 1 and the RIP processing apparatus 50 each mainly comprise an operation part 7 or 57 including a mouse, a keyboard or the like for inputting various instructions of an operator, a display part 8 or 58 such as a display, a storage part 9 or 59 including a hard disk or the like and storing a program 9p or 59p, respectively, for execution to cause the computer to function as the print inspection apparatus 1 or the RIP processing apparatus 50, an R/W part 10 or 60 for performing read/write of the data from/into the various portable recording media through the media reader/writer 5 or 55, respectively, a communication part 11 or 61 serving as an interface for transmission of data to/from the other apparatus on the network N and a control part 12 or 62 constituted of a CPU 12a or 62a, a ROM 12b or 62b and a RAM 12c or 62c, respectively, for performing functions as discussed later.

In the print inspection apparatus 1 and the RIP processing apparatus 50, a GUI(Graphical User Interface) where the individual operation is performed while operations of the operation part 7 or 57 and states and conditions of various processes are displayed on the display part 8 or 58 is achieved by the functions of the control part 12, the operation part 7 and the display part 8 in the print inspection apparatus 1 and by the functions of the control part 62, the operation part 57 and the display part 58 in the RIP processing apparatus 50. Operations of such parts in the control part 12 or 62 as discussed later are performed by using the GUI.

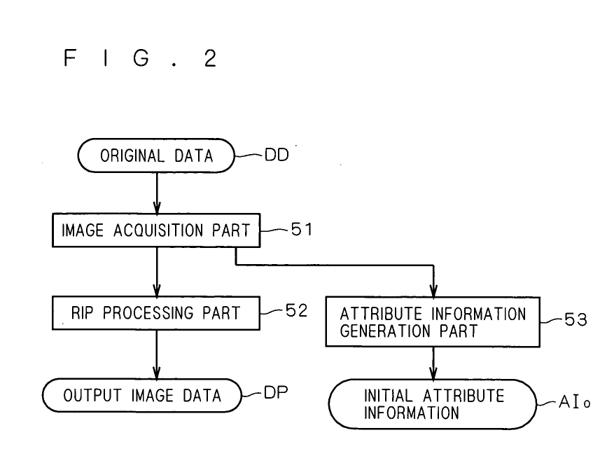

FIG. 2 is a view showing functions implemented in the control part 62 of the RIP processing apparatus 50. The RIP processing apparatus 50 mainly comprises an image acquisition part 51, an RIP processing part 52 and an attribute information generation part 53.

The image acquisition part 51 acquires original data described in, e.g., PDF which is an object for the RIP processing in accordance with an instruction through the operation part 57 and the display part 58. Preferably, the image acquisition part 51 performs a preflight check on whether original data DD is data suitable for output, such as whether a font used in the layout data is suitable for output or whether the resolution of an image is appropriate.

The RIP processing part 52 performs the RIP processing under a predetermined RIP processing condition on the basis of the original data DD. Through this RIP processing, output image data DP having a predetermined resolution is generated. In the first preferred embodiment, not only printing-plate generation data (e.g., separation output data for color separation) in the plate making apparatus 3 but also image data which is separately subjected to the RIP processing for inspection are referred to as output image data DP. The RIP processing can be performed by using a well-known technique.

On the basis of the content of the original data DD, the attribute information generation part 53 extracts information (referred to as layout information) on layout position and size of an object such as character or linework used in the layout of a printed matter which is given by the original data DD, to generate initial attribute information AI0. In the first preferred embodiment, an attribute means a type of each object in the original data DD and a type of image element such as character, linework or picture in the image data to be inspected. Generation of the initial attribute information AI0 will be discussed later. The initial attribute information AI0 is transmitted to the print inspection apparatus 1, accompanying the output image data DP when the output image data DP is inspected in the print inspection apparatus 1. Alternatively, the initial attribute information AI0 may be stored in a predetermined not-shown database on the network N. Further, the function of the attribute information generation part 53 may be implemented by an attribute information generation apparatus which is provided separately from the RIP processing apparatus 50. In this case, the attribute information generation apparatus is also implemented by the computer, like the RIP processing apparatus 50, and the same function as above can be achieved by executing a predetermined program.

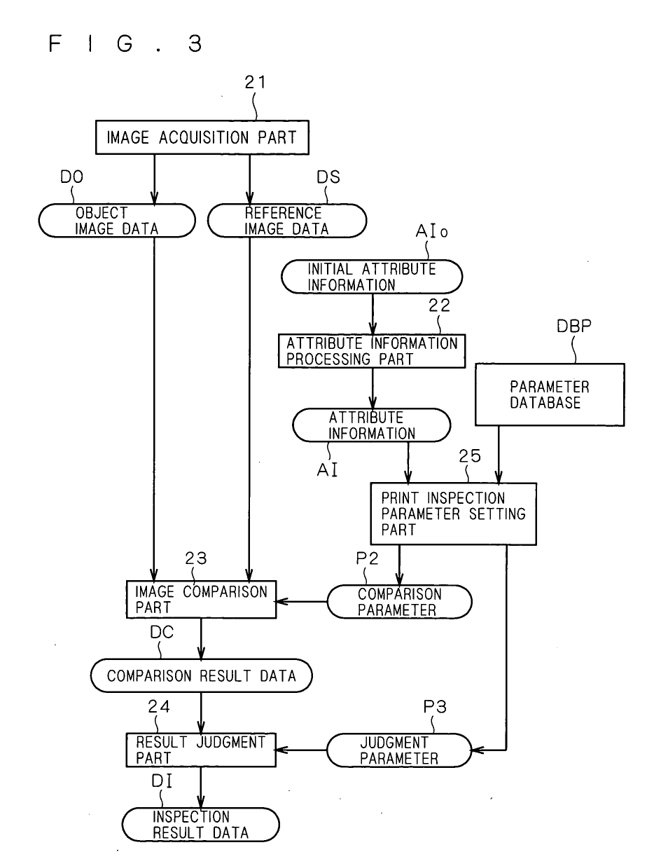

FIG. 3 is a view showing functions implemented in the control part 12 of the print inspection apparatus 1. In the control part 12 of the print inspection apparatus 1, the predetermined program 9p stored in the storage part 9 is executed by the CPU 12a, the ROM 12b and the RAM 12c, to implement functions of an image acquisition part 21, an attribute information processing part 22, an image comparison part 23, a result judgment part 24 and a print inspection parameter setting part 25. In a storage part 9, a parameter database DBP is implemented to store a comparison parameter P2, a judgment parameter P3, or the like.

The image acquisition part 21 acquires object image data DO to be inspected and reference image data DS serving as a reference for inspection, in accordance with an instruction given by an operator of print inspection apparatus through the operation part 7 and the display part 8. In this case, which type of image data is used as the object image data DO and the reference image data DS depends on the purpose of inspection. In a print inspection for the purpose of checking a result of RIP processing in the RIP processing apparatus 50, for example, output image data DP obtained from the primary original data DD for the first proof is used as the reference image data DS and output image data DP obtained from the revised original data DD which is corrected on the basis of a result of the first proof is used as the object image data DO. Alternatively, the object image data DO may be acquired by reading a proof with the image scanner 6, which is obtained from an output image data DP in a not-shown proof output apparatus, while the output image data DP may be used as the reference image data DS. Further, in a print inspection for the purpose of inspecting an image formed on a printing plate, printing-plate image data obtained by reading a printing-plate image from the printing plate of the second proof with the image scanner 6 can be used as the object image data DO and printing-plate image data at the first proof or the output image data DP at the first proof can be used as the reference image data DS. Also in a print inspection for the purpose of inspecting a printed matter which is outputted, image data obtained by reading a printing-plate image of a printed matter with the image scanner 6 can be used as the object image data DO and image data obtained from a printed matter before correction or a printing plate or the output image data DP can be used as the reference image data DS.

In any case, the object image data DO and the reference image data DS may be each acquired from the RIP processing apparatus 50 via the network N, to be stored in the storage part 9 in advance and read out from the storage part 9, or may be stored in a recording medium and read out therefrom through the media reader/writer 5.

The attribute information processing part 22 acquires the initial attribute information AI0 via the network N and generates attribute information AI on the basis of the initial attribute information AI0. As the initial attribute information AI0, information obtained in the RIP processing of the reference image data DS or that obtained in the RIP processing of the object image data DO may be used. The initial attribute information AI0 has description on layout information of each object on the basis of resolution and a layout size in the original data DD, but the resolution and the layout size in the original data DD and those in the object image data DO to be inspected are sometimes different from each other. In other words, respective unit values of those data in a coordinate system are sometimes different. In such a case, the initial attribute information AI0 can not be used itself in the print inspection. In the first preferred embodiment, the attribute information processing part 22 performs an affine transformation of a coordinate value on layout information and the like of an object in the initial attribute information AI0 to generate attribute information AI, and the attribute information AI is used in the print inspection. In other words, the attribute information processing part 22 also has a function as a coordinate transformation means to obtain attribute information.

The print inspection parameter setting part 25 sets the comparison parameter P2 used in the operation of the image comparison part 23 and the judgment parameter P3 used in the operation of the result judgment part 24 (these parameters are collectively referred to as a print inspection parameter) for each object on the basis of the attribute information AI and the type of image data to be inspected. At that time, the parameters are set on the basis of association data between the attribute information AI and the print inspection parameter, which is stored in, e.g., the parameter database DBP of the storage part 9. When a printing-plate image is inspected, for example, since the printing-plate image is monochrome data and scanning of the data is performed by the image scanner 6 sometimes with insufficient precision of halftone, the judgment parameter P3 is set so that a tone margin value (discussed later) of picture attribute may be larger than other attributes. Further, when a printed matter is inspected, since variation in character position is sometimes caused by variation in feed rate of paper in printing, the comparison parameter P2 is set so that a swing (shift) pixel range (discussed later) of character attribute may be larger than other attributes. The print inspection parameter may be set or corrected by the operator through the operation part 7 and the display part 8.

The image comparison part 23 performs calculation of difference in tone value between the object image data DO and the reference image data DS by corresponding pixels according to the comparison parameter P2 given in accordance with the attribute information Al of an object to which the pixel belongs, to generate comparison result data DC. Depending on the content of the comparison parameter P2, there may be a case where the comparison is performed after a swing (shift) operation to simultaneously generate a plurality of comparison result data DC of different operation conditions. The swing (shift) operation refers to a method where even when a layout position of a linework image or a picture image in object image data deviates from that in reference image data, and in other words, there is a pixel displacement, the pixel displacement can be cancelled to allow detection of a proper differential value or the like by virtually shifting (moving in parallel) the layout position of either image data and then comparing these image data with each other. In this case, a swing pixel range in the swing operation and the like are given as the comparison parameter P2. Further, in the image comparison part 23, the comparison operation may be performed selectively for an area having specific attribute information AI in accordance with operator's instruction given through the operation part 7 and the display part 8.

The result judgment part 24 judges whether the differential value obtained as the comparison result data DC is significant or not from the viewpoint of the purpose for the inspection in accordance with the criterion of judgment which is given by the judgment parameter P3 and consequently generates final inspection result data D1. As the judgment parameter P3, for example, given are a tone margin value which is the lower limit of significant differential value, an isolated point removal value serving as reference for removing a differential value of not 0 which is isolatedly present only within a very small range of pixels as an unnecessary isolated point, and the like. In the first preferred embodiment, since the judgment parameter P3 is set for each object, the judgment on the comparison result can be performed in accordance with a criterion suitable for the feature of each object.

<Attribute Analysis>

In the first preferred embodiment, the print inspection is performed by the print inspection apparatus 1 on the basis of a result of an attribute analysis which is made by the RIP processing apparatus 50 on the basis of the original data DD. Then, the attribute analysis will be discussed before discussion on the print inspection.

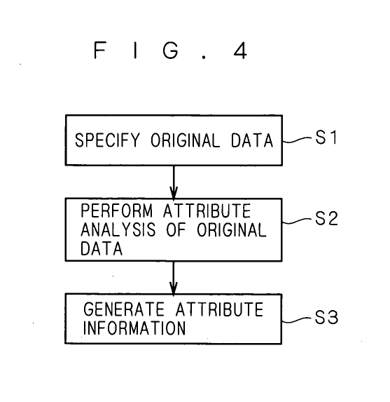

FIG. 4 is a flowchart showing operation flow of attribute analysis in the RIP processing apparatus 50 in accordance with the first preferred embodiment. An operator of the RIP processing apparatus 50 specifies the original data DD to be subjected to the RIP processing through the operation part 57 (Step S1). The original data DD may be stored in the storage part 59 in advance or may be read out from a predetermined recording media by the media reader/writer 55.

After reading the original data DD, the RIP processing is performed by the RIP processing part 52 and the attribute analysis is performed by the attribute information generation part 53 on each of objects constituting the layout of the original data DD (Step S2).

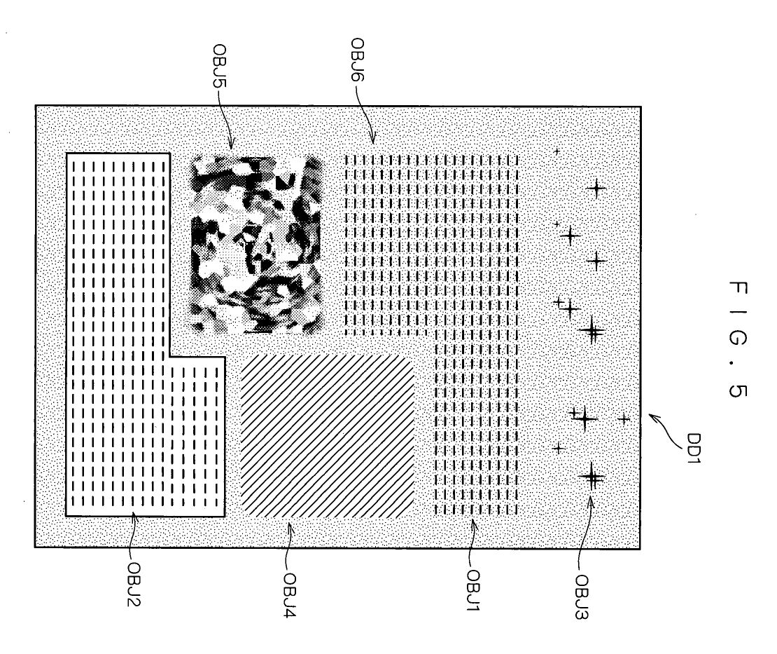

FIG. 5 is a view illustrating original data DD1 as an example of the original data DD. In the original data DD1, character objects OBJ1 and OBJ2, a linework object OBJ3, a gradation object OBJ4 (hatched for convenience of illustration), a picture object OBJ5 are arranged. In portions other than the character object OBJ2, the ground color is a tint and this may be considered as a tint object OBJ6. In other words, the character object OBJ1, the linework object OBJ3, the gradation object OBJ4 and the picture object OBJ5 overlap the tint object OBJ6. The attribute information generation part 53 acquires layout information on these objects, e.g., with the lower-left end as a point of origin.

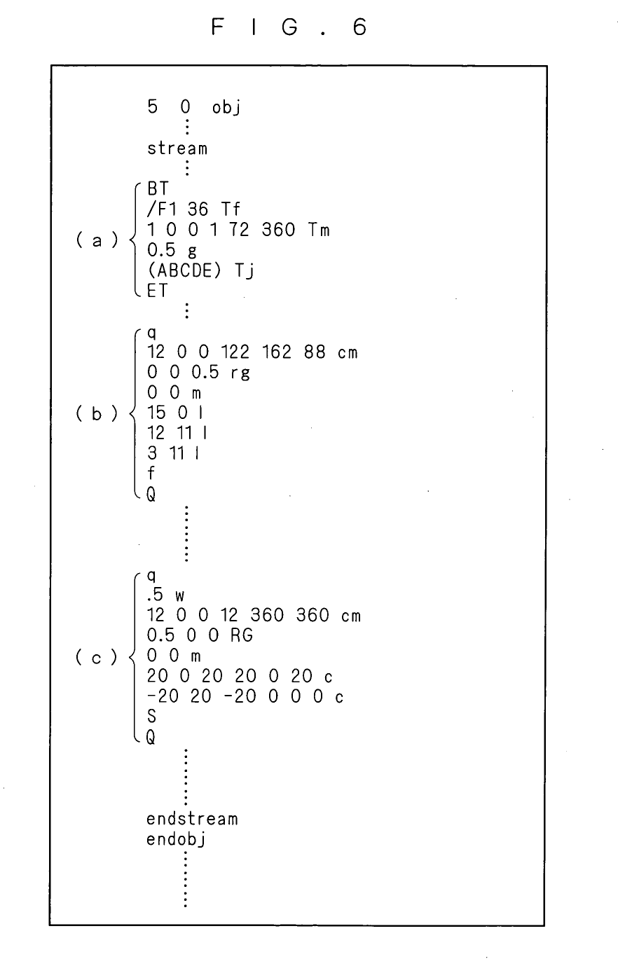

FIG. 6 is a view illustrating part of contents of the original data DD which is described e.g., in PDF. In a case of PDF, the content of the object is described in text format or binary format in accordance with the type of object and information on data structure, such as the layout information of an object, is described in text format in accordance with a predetermined grammar, and therefore the attribute information generation part 53 identifies an object in the original data DD in accordance with the description of the information and acquires the layout information on the object. For example, the part (a) of FIG. 6 indicates that a character string of “ABCDE”, i.e., a character object is arranged in a predetermined separately-specified font of 36 points with the coordinate position of (72, 360) as a starting point. The part (b) of FIG. 6 indicates that a solid filled trapezoid having a lower side of 15 points, an upper side of 12−3=9 points and a height of 11 points with 12/72=⅙ points as a unit, i.e., a picture object is arranged with the coordinate position of (216, 288) as a starting point. The part (c) of FIG. 6 indicates that an ellipse drawn by Bezier curve, having a major (longer) axis of 30 units long in the horizontal direction and a minor axis of 20 units long in the vertical direction, i.e., linework object is arranged with the coordinate position of (360, 360) as a starting point. Since other various objects are also arranged on the basis of descriptions in accordance with grammar, the attribute information generation part 53 acquires the layout information of objects on the basis of such descriptions.

As a result, in the attribute information generation part 53, the initial attribute information AI0 is generated in a predetermined format, which contains the acquired layout information of each object, identifying information for identifying the original data DD which has the acquired layout information, and plate number information for managing the plate number indicating which plate the original data DD represents (Step S3). For example, assuming that the identification number of an object is a, an attribute flag FA (discussed later) corresponding to an attribute of the object is b, the plate number of the original data DD is c and the layout information of the object is a function P(x, y) of the coordinate (x, y), the initial attribute information AI0 on the object is described in a format such as (a, b, c, P(x, y)).

The initial attribute information AI0 is transmitted to the print inspection apparatus 1 or a predetermined database, accompanying the output image data DP obtained by the RIP processing.

<Inspection for Printing>

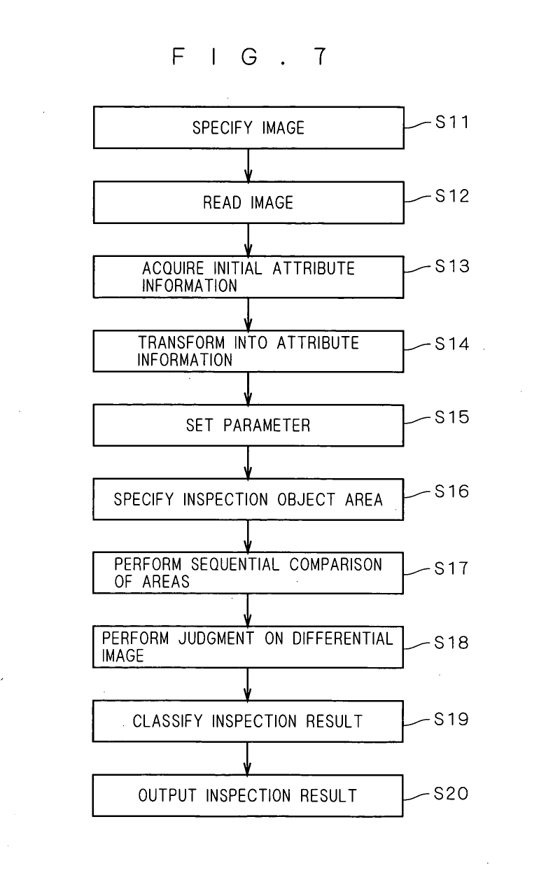

FIG. 7 is a flowchart showing operation flow of the print inspection apparatus 1 in accordance with the first preferred embodiment. In the first preferred embodiment, since there are various data to be inspected by the print inspection apparatus 1 but the print inspection operation is the same even though different data are used, discussion will be made below mainly on an exemplary case where the output image data DP obtained from the primary original data DD for the first proof is used as the reference image data DS and the output image data DP obtained from the revised original data DD after the proofing is used as the object image data DO.

First, an operator of the print inspection apparatus specifies the object image data DO to be inspected and the reference image data DS through the operation part 7 (Step S11), and then these image data are read into the RAM 12c by the operation of the image acquisition part 21 (Step S12). When the object image data DO and/or the reference image data DS is halftone image data, in reading the data, a descreening operation is performed for converting the halftone image data into multitone image data. The descreening operation can be performed by using a well-known technique.

Next, predetermined initial attribute information AI0 is acquired by the operation of the attribute information processing part 22 (Step S13), and the initial attribute information AI0 is transformed by affine transformation of coordinate value or the like, into attribute information AI usable in the print inspection (Step S14). The attribute information AI obtained by the above transformation corresponds to layout information of an image element such as character, linework or picture arranged in the object image data DO to be inspected and/or the reference image data. In other words, in the first preferred embodiment, since each image element is originally an object arranged in the original data DD and exact layout information of each object can be acquired from description of the original data DD, the initial attribute information AI0 obtained from the original data DD and the attribute information Al can be advantageously used as exact layout information of the image element.

It is preferable that as the initial attribute information AI0 to be transformed, information which is suitable in consideration for purpose and object of the print inspection should be used. When the output image data DP obtained by the RIP processing is used as the object image data DO to be inspected, for example, the initial attribute information AI0 transmitted accompanying the output image data DP can be used, but when the print inspection is performed at the revision and there is neither correction nor change in layout of the object, for example, the initial attribute information AI0 which is acquired at the first proofing and stored in the print inspection apparatus 1 or a not-shown database may be used. Even when a printing-plate image or a printed matter is inspected, since at least one RIP processing is performed, the initial attribute information AI0 obtained at any point of processing can be used.

After the object image data DO and the reference image data DS are acquired and the corresponding attribute information AI is generated, the print inspection parameter, i.e., the comparison parameter P2 and the judgment parameter P3, is set on each of objects constituting the object image data DO or the reference image data DS in accordance with the attribute and the type of image data on the basis of the content of the attribute information AI by the operation of the print inspection parameter setting part 25 (Step S15). This operation is performed, referring to the parameter database DBP.

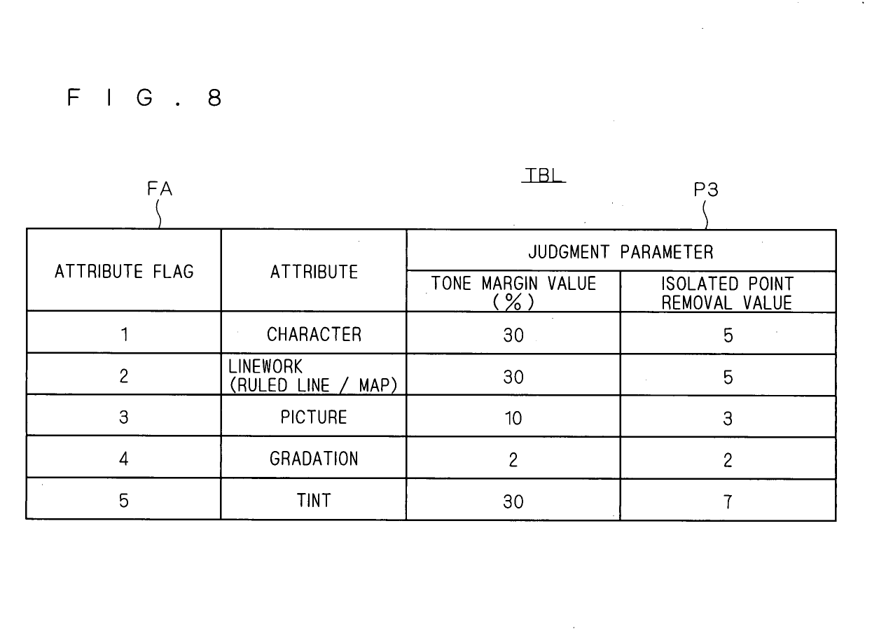

FIG. 8 shows a parameter table TBL as an example of setting of tone margin values and isolated point removal values in the judgment parameter P3 on a “character” attribute, a “linework” attribute, a “picture” attribute, a “gradation” attribute and a “tint” attribute. The attribute flags FA are given correspondingly to those attributes, respectively. In the parameter database DBP, additionally to these items, various contents including a swing pixel range (not shown) and the like as the comparison parameter P2 are stored in a predetermined format as the print inspection parameter. As the print inspection parameter, the data contents stored in the parameter database DBP may be used or corrections may be added to the contents as appropriate in accordance with the type of object image.

When the output image data DP which is obtained after the RIP processing on the basis of the original data DD1 of FIG. 5 is inspected, for example, since six objects which are classified into five attributes are arranged, the print inspection parameters are set for the respective objects. In this case, for example, since the character objects OBJ1 and OBJ2 are objects of the same attribute but the former is arranged in a tint area and the latter is not, the print inspection parameters further reflecting such difference can be set by setting the print inspection parameters for these objects with different values as appropriate.

The names of attributes of objects, such as “character” attribute and “picture” attribute, are given as a matter of convenience but not necessarily, and in the print inspection apparatus 1 and the RIP processing apparatus 50, the respective attributes can be uniquely identified by the attribute flags FA.

After the setting of the print inspection parameter is completed, an operator sets an area in the object image data DO which is to be inspected on the basis of the attribute information AI (Step S16). It is therefore possible to selectively specify an area to be inspected by the image element, to perform the print inspection. Further, a plurality of areas can be selected. For example, when the output image data DP which is obtained after the RIP processing on the basis of the original data DD1 of FIG. 5 is subjected to the print inspection and only an area corresponding to an object having “character” attribute with some change added to the first proof is intended for inspection, only the areas corresponding to the layout position of the character objects OBJ1 and OBJ2 are inspected.

After specifying the area to be inspected, comparison is sequentially performed between the object image data DO and the reference image data DS, on pixels in the area to be inspected, in accordance with the comparison parameter P2 set for the object to which the pixels belong, by the operation of the image comparison part 23 (Step S17). In other words, the comparison is performed, with the comparison parameter P2 changed by the area corresponding to each object. The comparison can be performed by a well-known technique.

When a swing (shift) operation is performed as the comparison, for example, assuming that the tone value of the reference image data for the pixel (i, j) is Gs(i, j) and that of the object image data is Go(i, j), pixel values m and n for shift are set as the comparison parameter P2. When the object image data DO is swung (with its pixel position shifted) by m pixels in the i direction and by n pixels (m, n: integers) in the j direction, a differential value ΔG (i, j) of the tone value is obtained as;

ΔG(i, j)=Go(i-m, j-n)−Gs(i, j) (Eq. 1-1)

Repeating the computation of Eq. 1-1 with the values m and n changed by the area corresponding to each object as the comparison parameter P2, a plurality of comparison result data DC are consequently obtained.

After the comparison result data DC is obtained, a differential-image judgment operation for judging whether the comparison result data DC has a significant difference or not is performed on the area corresponding to each object in accordance with the judgment parameter P3 set for the attribute of the object by the operation of the result judgment part 24 (Step S18).

Only significant differences are extracted as the result of judgment, so that the result is classified according to the attribute of the area where the difference is caused on the basis of the attribute information AI (Step S19), the inspection result data DI is outputted (Step S20). The print inspection result DI is stored in the storage part 9 and displayed on the display part 8.

As discussed above, in the first preferred embodiment, since the print inspection parameter reflecting the attribute and the layout information of each of the objects arranged in the original data DD described in, e.g., PDF format is set by the area which is specified by the layout information of the object, even if image areas of different attributes are mixed in the object image data DO, an optimum print inspection for each image area can be performed and it is therefore possible to efficiently obtain a significant result at one operation on the whole of the object image data DO.

Specifically, this makes it easier to ignore a difference of tone value which is caused at an edge boundary by a half-pixel displacement but may not be detected from the viewpoint of human's visual property or strictly judge whether there is any difference of tone value in a gentle gradation area.

Further, since the print inspection can be performed on only an area occupied by an image element corresponding to a specific attribute, this allows a faster inspection. Furthermore, since the result is classified according to the attribute of an area where the difference is caused, the analysis of the print inspection result becomes easier, and it becomes therefore possible to take a countermeasure for the result and improve the operation efficiency.

Moreover, since the print inspection can be performed on output image data obtained from original data, a printing-plate image generated on the basis of the output image data and a printed matter outputted by using the printing plate, by using one attribute information obtained on the basis of the original data, when the print inspection result is NG, systematic check and judgment on a process having the cause of NG result in a work flow becomes easier.

<Variation of The First Preferred Embodiment>

Though the print inspection operation can be performed for the area corresponding to each of arranged objects in the above-discussed first preferred embodiment, setting of areas is not limited to the above case.

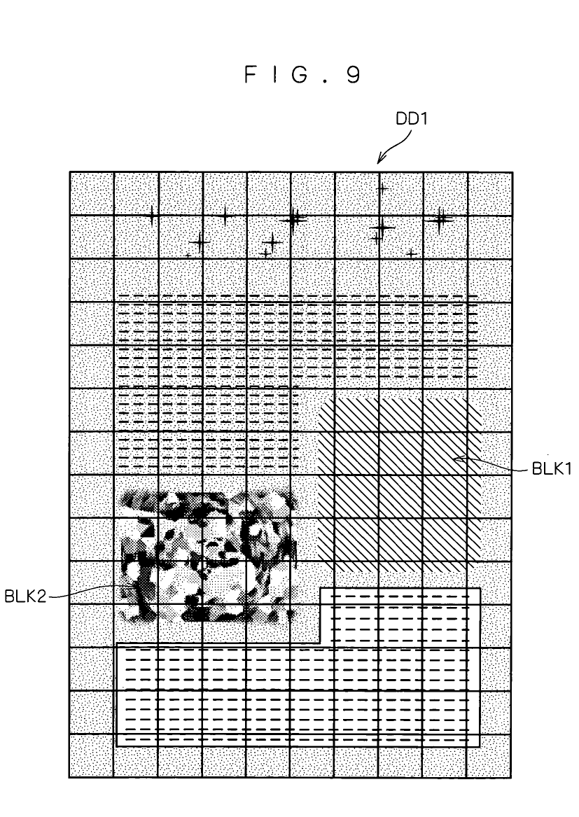

There may be a case, for example, where the original data DD is subjected to the RIP processing in the RIP processing part 52, separately from the output image data, to generate image data (coarse RIP processing data) consisting of coarse pixels of about 72 dpi (the pixels are referred to as a block area). Then, in the attribute information generation part 53, the attribute of each block area is analyzed on the basis of a content of the coarse RIP processing data to generate the initial attribute information AI0. FIG. 9 is a view showing a case of generating the initial attribute information AI0 by the above method. In FIG. 9, it is assumed that the original data DD1 of FIG. 5 is subjected to the above operation. Each rectangular area corresponds to one unit of block area. The attribute information generation part 53 judges which attribute each block area mainly has, to generate the initial attribute information AI0 in a unit of block area. For example, it is judged that a block area BLK1 is a gradation area and a block area BLK2 is a picture area. Assuming that the attribute flag FA corresponding to the attribute of a block area BLK(p, q) is b and the plate number of the original data DD is c, the initial attribute information AI0 is described in a format of (p, q, b, c) or the like on each object.

The print inspection apparatus 1 specifies an attribute to be inspected and selectively inspects only a block area having the attribute. Even by such an operation, the inspection result data DI can be also obtained.

<The Second Preferred Embodiment>

<System Configuration>

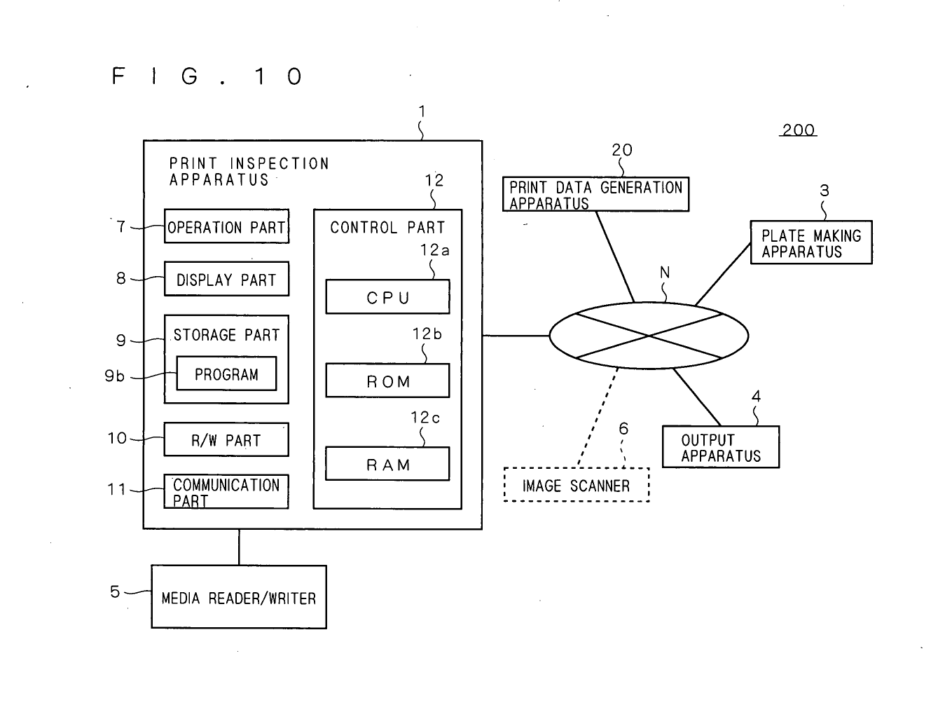

FIG. 10 is a schematic diagram illustrating a constitution of a printing system 200 including the print inspection apparatus 1 in accordance with the second preferred embodiment of the present invention. Most of constituent elements in the printing system 200 are the same as those of the printing system 100 of the first preferred embodiment. These common elements are represented by the same reference signs and description thereof will be omitted.

The printing system 200 mainly comprises the print inspection apparatus 1, a print data generation apparatus 20, the plate making apparatus 3 and the output apparatus 4, where these apparatus are electrically connected with one another via the network N such as LAN (Local Area Network), to perform a printing work flow consisting of generation of print data, plate making, and output.

The print data generation apparatus 20 generates print data through a layout of a print image, such as typesetting and image arrangement. The generated print data is subjected to the RIP processing (rasterization processing) to become multitone image data, and the image data is subjected to a post-stage work flow such as an inspection for printing. In other words, the print data generation apparatus 20 has a constitution in which the layout apparatus 2 and the RIP processing apparatus 50 of the first preferred embodiment are united and achieves the functions of these apparatus. Naturally, these apparatus may be provided independently like in the first preferred embodiment. In this case, the layout data generated in the layout apparatus 2 is transmitted to the RIP processing apparatus 50 and subjected to the RIP processing, and thus the same function of the print data generation apparatus 20 can be achieved on the whole. Alternatively, there may be a case where the print inspection apparatus 1 has the function of performing the RIP processing and the print data generation apparatus 20 only performs the layout and transmits the layout data to the print inspection apparatus 1, and then the print inspection apparatus 1 performs the RIP processing of the layout data and after that, performs the inspection for printing.

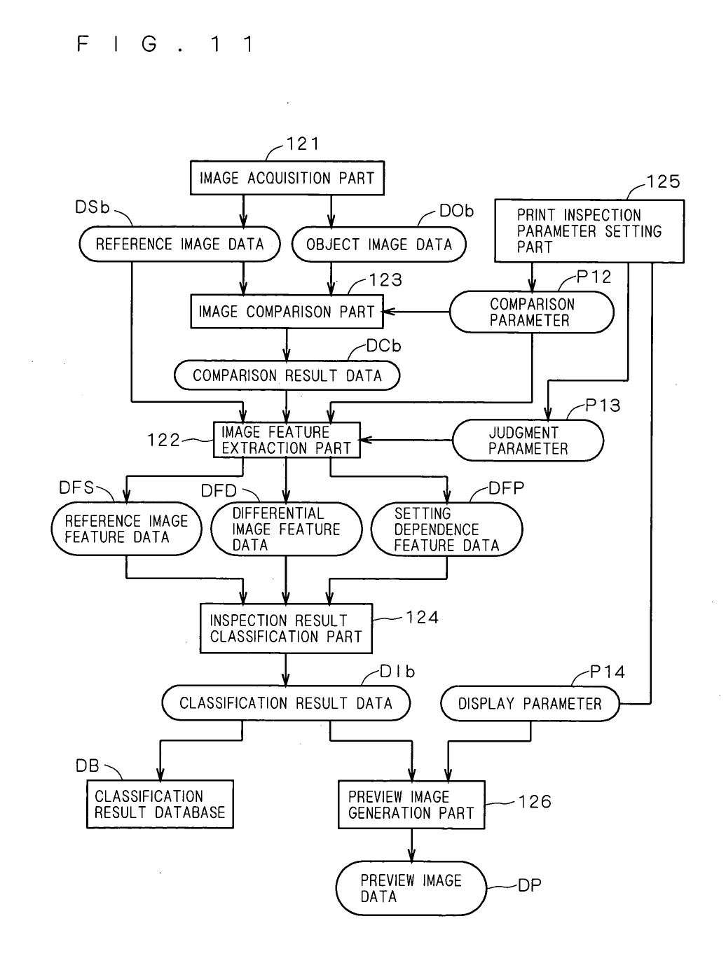

FIG. 11 is a view showing functions inplemented in the control part 12 of the print inspection apparatus 1.

In the control part 12, a predetermined program 9b stored in the storage part 9 of the print inspection apparatus 1 is executed by the CPU 12a, the ROM 12b and the RAM 12c, to mainly implement functions of an image acquisition part 121, an image feature extraction part 122, an image comparison part 123, an inspection result classification part 124, a print inspection parameter setting part 125 and a preview image generation part 126.

The image acquisition part 121 acquires object image data DO which is image data to be inspected and reference image data DS which is image data serving as a reference for inspection, in accordance with the instruction given from the operator of the print inspection apparatus through the operation part 7 and the display part 8. As these data, data which is transmitted from the print data generation apparatus 20 via the network N and stored in the storage part 9 in advance may be acquired from the storage part 9, or data stored in a recording medium may be acquired therefrom through the media reader/writer 5. Reference image data DSb is, for example, print image data at the first proofing and object image data DOb is revised print image data which is corrected on the basis of a result of the first proof.

The image comparison part 123 performs calculation of difference in tone value between the object image data DOb and the reference image data DSb by corresponding pixels in accordance with a comparison parameter P12, to generate comparison result data DCb. Depending on the content of the comparison parameter P12, there may be a case where the comparison is performed after the swing (shift) operation to simultaneously generate a plurality of comparison result data DCb under different operation conditions. In this case, the swing pixel range in the swing operation and the like are given as the comparison parameter P12. There may be another case where a predetermined threshold value for the differential value (the threshold value is referred to as tone margin) is given as the comparison parameter P12 and a differential value larger than the tone margin value is considered as a significant differential value. The comparison result data DCb simply indicates data of result obtained by calculation of the differential value, and image data corresponding to a differential image indicating a distribution of actual differential values is particularly referred to as differential image data DD.

The image feature extraction part 122 extracts a feature of the print inspection result on the basis of the comparison result data DCb, to generate reference image feature data DFS, differential image feature data DFD and setting dependence feature data DFP. In other words, the image feature extraction part 122 has functions of a differential image feature extraction means, a reference image feature extraction means and a setting dependence feature extraction means. The differential image feature data DFD is data indicating an image feature of the differential image from the shape and area of the differential area found in the differential image. The reference image feature data DFS is data to link the differential area of the differential image with an image feature of a corresponding area in the reference image. The setting dependence feature data DFP is data indicating a relation between the content of the comparison parameter P12 defining the method of comparison operation and the criterion of whether there is any difference and the differential image. Specifically, the setting dependence feature data DFP is data indicating a relation between a swing pixel range and occurrence of a differential area, or a relation between setting of a tone margin which is a lower limit of a significant differential value and occurrence of a differential area. Generation of the reference image feature data DFS and the reference image feature data DFD is performed, referring to a judgment parameter P13 serving as a criterion for judgment on whether there is any image feature. The reference image feature data DFS, the differential image feature data DFD and the setting dependence feature data DFP are used for classification of the print inspection result discussed below. Generation of the reference image feature data DFS, the differential image feature data DFD and the setting dependence feature data DFP will be discussed later in detail.

The inspection result classification part 124 classifies the differential area found in the differential image according to its feature on the basis of the contents of the comparison result data DCb, the reference image feature data DFS, the differential image feature data DFD and the setting dependence feature data DFP, to classify the inspected object image data DOb into a predetermined category. For example, possible categories are as follows, from the viewpoint of area in the reference image data DSb where the existing differential area is caused:

1) difference is found only in the “picture” area

2) difference is found only in the “character” area

3) difference is found only in the “tint” area

4) difference is found in the “picture” area and the “character” area

5) difference is found in the “picture” area and the “tint” area

6) difference is found in the “character” area and the “tint” area

7) difference is found in all the “picture” area, the “character” area and the “tint” area

8) no difference is found

Among these categories, 1) to 3) correspond to individual categories as a unit of area classification and 4) to 7) correspond to conglomerate categories over a plurality of area classification units.

Additionally to this, classification according to the shape of the differential area, classification depending on the comparison method or the like are performed.

Further, a classification result of the differential area found in the differential image is stored in the storage part 9 as classification result data DIb. The classification result data DIb is stored in a classification result database DB implemented in the storage part 9.

The print inspection parameter setting part 125 sets the comparison parameter P12, the judgment parameter P13 and a display parameter P14 used for generation of a preview image as discussed below (collectively referred to as “print inspection parameter”). In accordance with the print inspection parameter set by the operator through the operation part 7 and the display part 8, the operations of these parts are performed.

The preview image generation part 126 generates preview image data DP for data display on the basis of the classification result data DIb. The preview image data DP is generated so that the differential area may be displayed in a display format where visual identifiability is higher (than other areas) according to its feature in accordance with the content of the display parameter P14. The display parameter P14 is a parameter on setting for visually identifiable display of each differential area in a preview image, such as coloring a differential area found in the picture area with blue and coloring a differential area found in the character area with red. Further, the differential area may be displayed on the inspection object image by dividing layers according to the feature of each differential area. The preview image displayed on the display part 8 on the basis of the preview image data DP may be an image having resolution coarser than that of the inspection object image or the differential image.

<Inspection for Printing and Generation of Control Information>

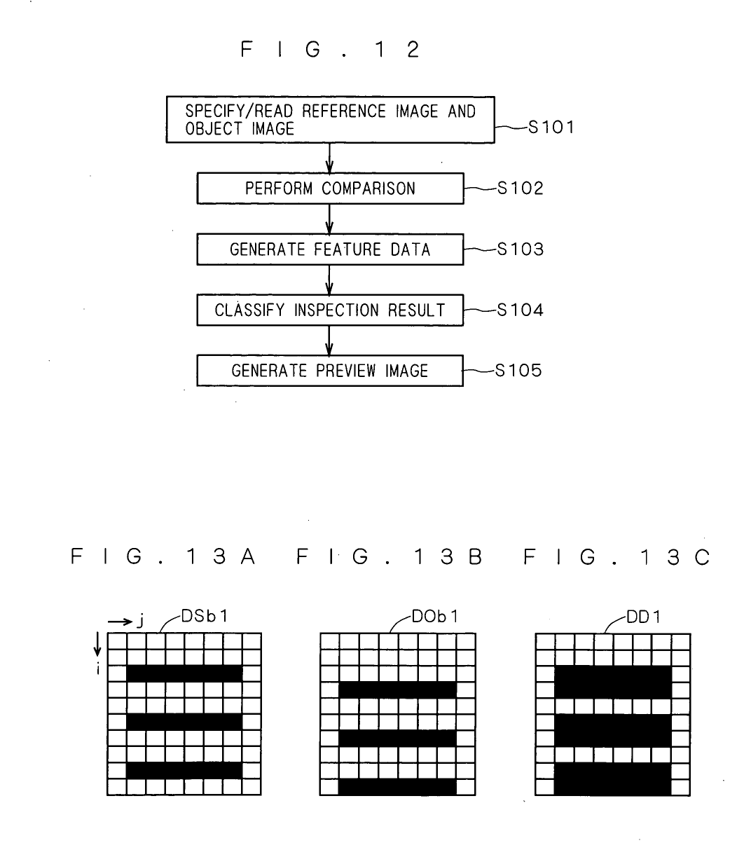

FIG. 12 is a flowchart showing operation flow of print inspection in the print inspection apparatus 1 in accordance with the second preferred embodiment. Discussion will be made below, referring to FIG. 12.

First, the operator of the print inspection apparatus 1 specifies the object image data DOb and the reference image data DSb which are to be subjected to the print inspection through the operation part 7, and then these image data are read into the RAM 12c by the operation of the image acquisition part 121 (Step S101).

After the reference image data DSb and the object image data DOb are acquired, comparison between these image data is performed by the operation of the image comparison part 123 (Step S102). This comparison can be performed by a well-known technique.

For example, assuming that the tone value of the reference image data DSb for the pixel (i, j) is Gs(i, j) and that of the object image data DOb is Go(i, j) (where the tone value is given as any value of 256 tones in a range from 0 to 255), when the object image data DOb is swung (with its pixel position shifted) by m pixels in the i direction and by n pixels (m, n: integers) in the j direction, a differential value ΔG (i, j) of the tone value is obtained as;

ΔG(i, j)=Go(i-m, j-n)−Gs(i, j) (Eq. 2-1)

The shifted pixel values m and n in the swing (shift) operation are given as the comparison parameter P12. Repeating the computation of Eq. 2-1 with the values m and n changed, a plurality of comparison result data DCb can be consequently obtained. The comparison result data DCb can be displayed on the display part 8 as the differential image between the reference image and the object image.

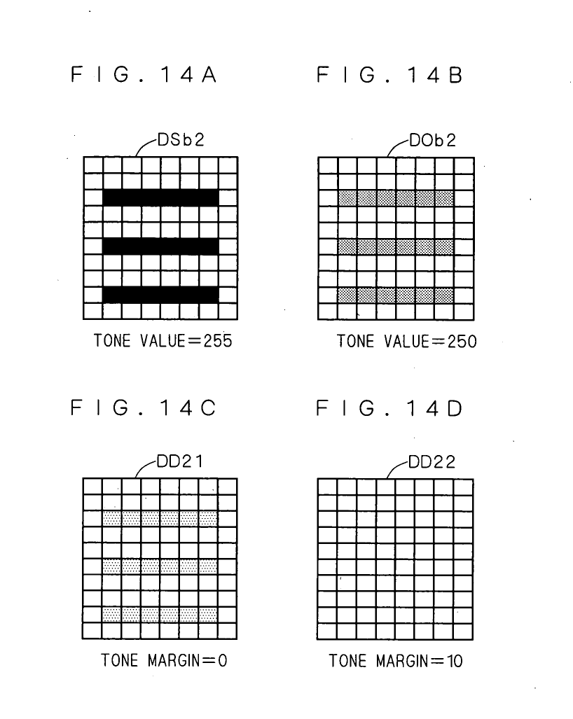

FIGS. 13A to 13C are views showing an example of swing (shift) operation. For simple illustration, the tone margin is not taken into consideration. Though reference image data DSb1 of FIG. 13A and object image data DOb1 of FIG. 13B represent images of the same content, since the layout of image is shifted by one pixel in the i direction, differential image data DD1 is obtained as shown in FIG. 13C when the comparison is performed between these data. The differential image data DD1 represents the differential value in absolute value. In this case, when the comparison of Eq. 2-1 is performed by using the comparison parameter P12 indicating m=−1 and n=0, it is true that the differential value ΔG (i, j)=0 regardless of the pixel (i, j), and no difference is detected.

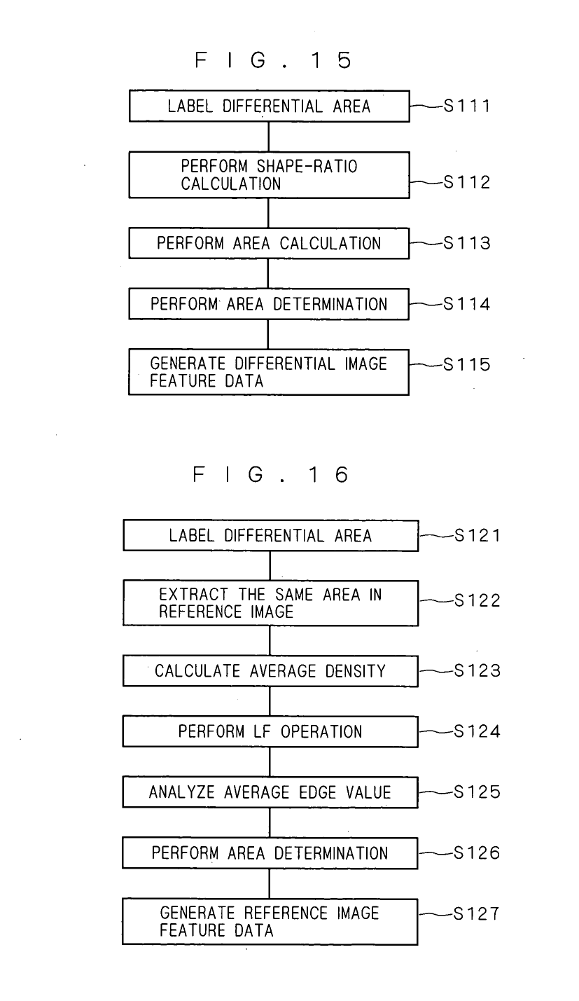

FIGS. 14A to 14D are exemplary settings of tone margin. For simplification, it is assumed that no swing operation should not be performed. Though reference image data DSb2 of FIG. 14A and object image data DOb2 of FIG. 14B have the same layout position of images, there is a difference in that the tone margin value of the reference image data DSb2 is 255 and that of the object image data DOb2 is 250. When the comparison is performed with a tone margin of 0, differential image data DD21 is obtained, having a differential value of 5 obtained by Eq. 2-1, as shown in FIG. 14C. On the other hand, with a tone margin of, e.g., 10, as shown in FIG. 14D, it is judged that the differential value of 5 is not a significant value and differential image data DD22 entirely having a differential value of 0 is obtained.

After the differential image data DD is obtained, the differential image feature data DFD, the reference image feature data DFS and the setting dependence feature data DFP are generated by the operation of the image feature extraction part 122 (Step S103). In this case, the setting dependence feature data DFP is generated by describing association information between the content of the comparison parameter P12 used for the above comparison and the differential image data DD, in a predetermined format.

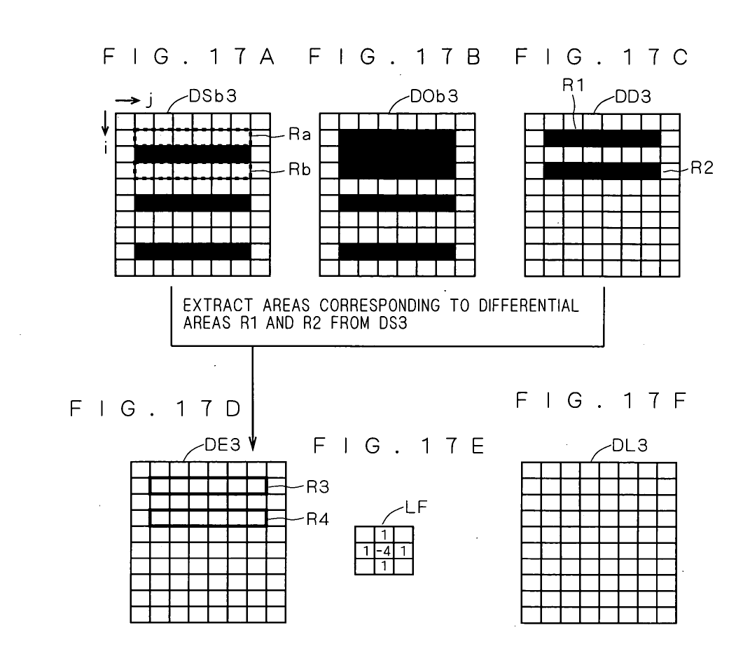

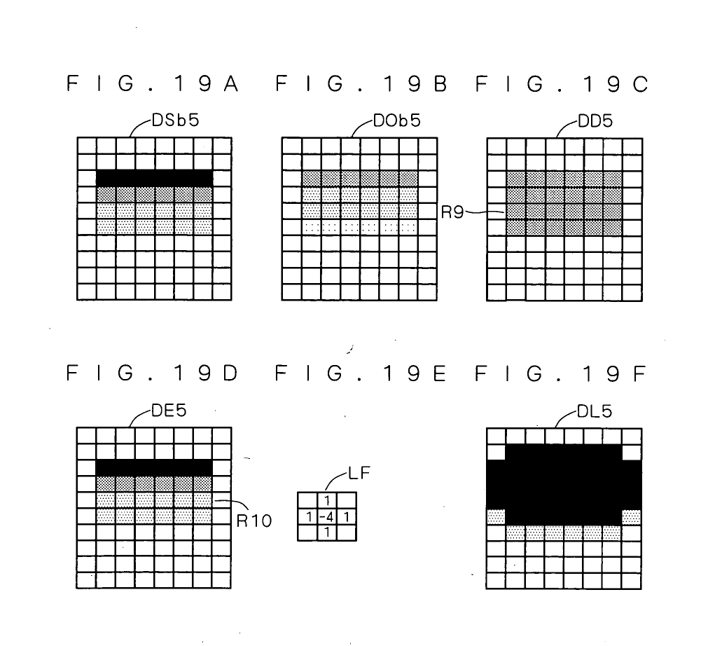

FIG. 15 is a flowchart showing operation flow for generating the differential image feature data DFD. After the differential image data DD is obtained, first, a labeling operation for giving labels to distinguish areas (differential areas) from each other, which are formed of pixels having difference which are arranged adjacently in the differential image (Step S111). The labeling operation can be performed by a well-known technique. In a case of FIGS. 17A to 17F, for example, differential image data DD3 of FIG. 17C is obtained from reference image data DSb3 of FIG. 17A and object image data DOb3 of FIG. 17B (both of which are image data of linework) and two differential areas R1 and R2 are formed in the differential image represented by the differential image data DD3, and therefore labels of e.g., “1” and “2” for distinguishing the areas are given to pixels constituting the respective areas in the labeling operation.

After the labeling operation, a shape-ratio calculation is performed on the areas R1 and R2 (Step S112). In the shape-ratio calculation, a vertical ratio and a horizontal ratio which correspond to an aspect ratio of the two directions are calculated as a length-to-width ratio in the number of pixels of the differential area. Assuming that the minimum coordinate value in the i direction of the pixels constituting the differential area is im, the maximum coordinate value is iM, the minimum coordinate value in the j direction is jm and the maximum coordinate value is jM, the vertical ratio and the horizontal ratio are obtained as:

vertical ratio=(iM−im)/jM−jm) (Eq. 2-2)

horizontal ratio=(jM−jm)/(iM−im) (Eq. 2-3)

The areas R1 and R2 of FIG. 17C each occupy one pixel in length and six pixels in width and can be obtained more simply as:

$$\begin{matrix}\begin{matrix}vertical ratio = ( the number of pixels in length ) / ( the \\ number of pixels in width ) \\ = 1 / 6 = 0.166\end{matrix} & ( Eq . 2 \text{-} 4 ) \\ \begin{matrix}horizontal ratio = ( the number of pixels in width ) / ( the \\ number of pixels in length ) \\ = 6 / 1 = 6\end{matrix} & ( Eq . 2 \text{-} 5 )\end{matrix}$$

Subsequently to the shape-ratio calculation, an area calculation is performed (Step S113). The area calculation is performed by counting the number of pixels occupying each area, i.e., the number of pixels with the same label.

Then, on the basis of the results of these calculations, an area determination is performed to determine the shape of the differential area (Step S114). At that time, the condition for determining the area is given as the judgment parameter P13. For example, if the condition for the differential area to be a “linework” area is

the vertical ratio<2, and the horizontal ratio>3 (Eq. 2-6)

or

the vertical ratio>3, and the horizontal ratio<2 (Eq. 2-7),

since the results of Eq. 2-4 and Eq. 2-5 satisfy Eq. 2-6, it is judged that both the areas R1 and R2 are linework areas. Actually, by giving various conditions for determination with combination between the result of shape-ratio calculation and that of area calculation, it is possible to perform determination of more complicate shapes.

After the area determination is performed, association information between the differential image data DD and information (label, shape ratio, area, type of area) on all the differential areas in the differential image data DD is described in a predetermined format, to generate the differential image feature data DFD (Step S115).

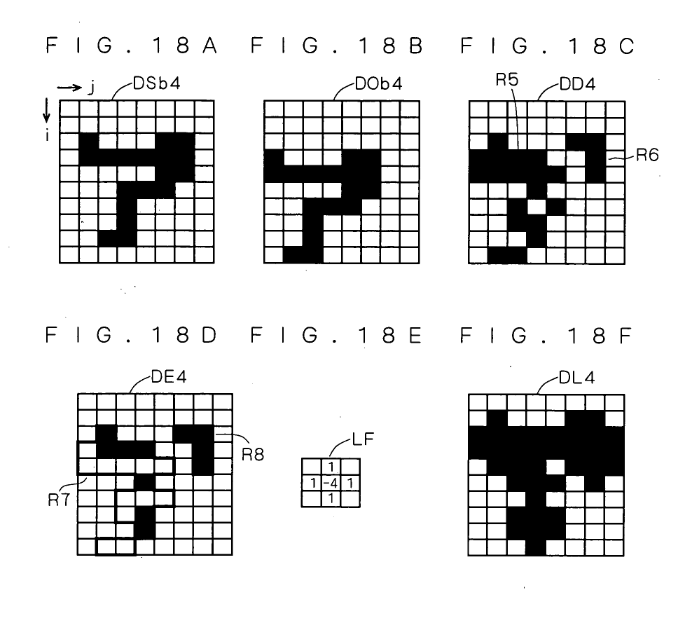

FIG. 16 is a flowchart showing operation flow for generating the reference image feature data DFS. FIGS. 17A to 17F, 18A to 18F and 19A to 19F are views showing generation of the reference image feature data DFS. FIGS. 17A to 17F, 18A to 18F and 19A to 19F show that the object image is a linework, characters and a picture, respectively.

Also in generation of the reference image feature data DFS, the labeling operation is performed like in generation of the differential image feature data DFD (Step S121). Alternatively, the result of Step S111 may be used.

After the labeling operation, an image content at a position corresponding to each differential area is extracted from each reference image data DSb (Step S122). In a case of FIGS. 17A to 17F, image contents of areas Ra and Rb in the reference image data DSb3 corresponding to the differential areas R1 and R2 in the differential image data DD3 are extracted, to generate extraction data DE3.

Next, on pixels having a tone value of not 0 in the extraction data, an average value of tone values i.e., average density is calculated (Step S123).

Subsequently, a Laplacian filter operation (referred to as LF operation) is performed by using a Laplacian filter LF shown in FIG. 17E over the extraction data (Step S124). An absolute value of ratio value obtained for each pixel as the result of LF operation corresponds to a value indicting an edge component value of the extraction data.

After obtaining the image data as the result of LF operation, an average edge value is calculated by adding up the edge component values and dividing the total edge component value by the number of pixels (Step S125).

After the average density and the average edge value are obtained, an area determination is performed on the basis of these results to determine the type of an area obtained as the extraction data, i.e., an area in the reference image corresponding to the differential area (Step S126). The condition for determining the area is given as the judgment parameter P13.

When the average density is 0 or 255, for example, the area is judged to be a “linework” area or a “character” area. When the average density is larger than 0 and smaller than 255, the area is judged to be a “picture” area. Further, the “linework” area and the “character” area are distinguished depending on whether the average edge value is larger than a predetermined threshold value or not. When the average edge value is smaller than the threshold value, the area is judged to be a “linework” and when larger, the area is judged to be a “character” area.

After the area determination, association information between the labels of all the differential areas in the differential image data DD and types of corresponding areas in the reference image data is described in a predetermined format, to generate the reference image feature data DFS (Step S127).

In FIGS. 17A to 17F, in both the reference image data DSb3 and the object image data DOb3, it is assumed that the tone value of a pixel (black pixel) having a tone value of not 0 is 255. In the differential image data DD3 obtained from these data, the two areas R1 and R2 are generated as differential areas as discussed above (see FIG. 17C). Areas R3 and R4 in the extraction data DE3 correspond to respective extracted image contents (see FIG. 17D) and since all the pixels in both the areas Ra and Rb in the original reference image data DSb3 have a tone value of 0 (see FIG. 17A), all the pixels in the extraction data DE3 have a tone value of 0 (see FIG. 17D). Therefore, since there is no pixel having a tone value of not 0, the average density becomes 0. Further, since the average edge value obtained from LF-operated data DL3 becomes 0 (see FIG. 17F), it is judged that the differential areas R1 and R2 are present at a position of the linework area in the reference image.

Also in FIGS. 18A to 18F, in both reference image data DSb4 and object image data DOb4, it is assumed that the tone value of a pixel having a tone value of not 0 is 255. In differential image data DD4, areas R5 and R6 are present (see FIG. 18C). As the result of extraction in these areas, some pixels having a tone value of not 0 are contained in part of areas R7 and R8 in the extraction data DE4 corresponding to the areas R5 and R6 and the tone values of all of such pixels are 255 (see FIG. 18D). In this case, the average density is 255, and when the average edge value obtained from LF-operated data DL4 is judged to be larger than a predetermined threshold value (see FIG. 18F), the differential area is judged to be present at a position corresponding to the “character” area in the reference image. The threshold value is appropriately set in the judgment parameter P13, and it is possible to control identifiability (identification capability) according to the image content by changing the set conditions.

In FIGS. 19A to 19F, it is assumed that reference image data DSb5 and object image data DOb5 have the same layout position but there are gradations in both data as the tone values of pixels having tone values of not 0 are not uniform (see FIG. 19A and 19B). In differential image data DD5 of this case, an area R9 is present as a differential area at the same position as images of these data (see FIG. 19C). Therefore, extraction data DE5 obtained by extraction have the same content as the reference image data DSb5 (see FIG. 19D). Accordingly, the extracted image has gradation and the average density is neither 0 nor 255. Thus, it is judged that the differential area is present at a position corresponding to a picture area in the reference image, regardless of the average edge value obtained from LF-operated data DF5 (See FIG. 19F).

After the differential image feature data DFD, the reference image feature data DFS and the setting dependence feature data DFP are generated, the print inspection result is automatically classified into a predetermined category on the basis of the shape of the differential area, the type of area (image feature) where the differential area is caused, the set contents in the comparison in a case of causing the differential area, and the like, to generate classification result data DIb indicating the result by the operation of the inspection result classification part 124 (Step S104). The classification result data DIb is stored in a classification result database DB.

After the classification result data DIb is generated, preview image data DP representing a preview image for displaying the print inspection result on the display part 8 is generated by the operation of the preview image generation part 126 (Step S105). As discussed above, according to the content of the display parameter P14, it is possible to change the display color in accordance with the type of image at a portion of the differential area, and so on. Alternatively, there may be a case where the change in differential image accompanying the change in set value of the swing pixel range can be displayed. The preview image, associated with the original classification result data DIb, is displayed on the display part 8. The operator may check the inspection result by visual check of the preview image. Since the preview image achieves an easy-to-see display of the inspection result in accordance with the content, the operator can easily make certain of the inspection result.

As discussed above, in the print inspection apparatus 1 of the second preferred embodiment, the print inspection result is automatically classified into a predetermined category and the classification result data DIb indicating the result is generated. Thereby the inspection result can be classified and organized without operator's one-by-one visual check. In a case of inspection of many images, the operation efficiency is dramatically improved. Further, it is possible to easily make certain of the inspection result by the preview image. By referring to the classification result database DB storing the classification result data DIb as appropriate, extraction and analysis of specific tendency found in the inspection result can be easily performed and when an unexpected inspection result is brought, it is also possible to obtain information serving as a clue to early solution of its cause.

While the invention has been shown and described in detail, the foregoing description is in all aspects illustrative and not restrictive. It is therefore understood that numerous modifications and variations can be devised without departing from the scope of the invention.

What is claimed is:

1. A printing system comprising:
a) a rasterization processing apparatus which comprises
a-1) a rasterization processing element for performing a rasterization processing of layout data to generate output image data; and
a-2) an attribute information generation element for generating first attribute information containing an attribute and layout information of an object which is a constituent of said layout data, and
b) a print inspection apparatus which comprises
b-1) a comparison element for comparing inspection object data with reference data to perform a print inspection, said inspection object data being said output image data or image data acquired in a processing on the basis of said output image data and said reference data representing an image as a reference for comparison with said inspection object data; and
b-2) an attribute information processing element for generating second attribute information on the basis of said first attribute information, said second attribute information being information on an attribute and layout information of an image element which is a constituent of said inspection object data or said reference data,
wherein said print inspection apparatus performs said print inspection selectively for each area with one attribute of said image element in said inspection object data or said reference data.

2. The printing system according to claim 1, wherein
said attribute information processing element comprises
b-2-1) a coordinate transformation element for transforming a coordinate value of said first attribute information into a coordinate value suitable for said inspection object data, to generate said second attribute information.

3. The printing system according to claim 2, wherein
said print inspection apparatus further comprises
b-3) a print inspection parameter setting element for setting a predetermined print inspection parameter to be used in a print inspection operation, said print inspection parameter being set for said each area.

4. The printing system according to claim 3, wherein
said print inspection parameter setting element sets said print inspection parameter on said each area on the basis of said second attribute information.

5. The printing system according to claim 4, wherein
said print inspection apparatus further comprises
b-4) a print inspection parameter database for storing said print inspection parameter in advance.

6. A printing system which generates print image data and performs at least one of plate making and output on the basis of said print image data, comprising:
a print inspection apparatus which comprises
a) a comparison element for comparing inspection object data with reference data to perform a print inspection, said inspection object data acquired in a processing of print image data and said reference data representing an image condition as a reference for comparison with said inspection object data;
b) a feature extraction element for extracting a feature of a print inspection result; and
c) a classification element for classifying said print inspection result on the basis of said feature.

7. The printing system according to claim 6, wherein
said feature extraction element comprises at least one of
b-1) a differential image feature extraction element for extracting a feature of a differential area appearing in a differential image which is represented by differential image data obtained as said print inspection result;
b-2) a reference image feature extraction element for extracting an image feature of an area in said reference data corresponding to said differential area; and
b-3) a setting dependence feature extraction element for extracting a feature of said print inspection result which depends on setting of a processing condition in said print inspection.

8. The printing system according to claim 7, wherein
said print inspection apparatus further comprises
d) a preview image generation element for generating preview image data on the basis of a classification result obtained by said classification element, said preview image data being image data used for being displayed on a predetermined display means so that said feature of said print inspection result can be visually identified in accordance with its content.

9. The printing system according to claim 8, wherein
said print inspection apparatus further comprises
e) a classification result database for storing said classification result obtained by said classification element.

10. An attribute information generation apparatus comprising:
a) a layout data acquisition element for acquiring layout data; and
b) an attribute information generation element for generating attribute information containing an attribute and layout information of an object which is a constituent of said layout data.

11. A rasterization processing apparatus comprising:
a) a rasterization processing element for performing a rasterization processing of layout data to generate output image data; and
b) an attribute information generation element for generating attribute information containing an attribute and layout information of an object which is a constituent of said layout data.

12. A print inspection apparatus comprising:
a) a comparison element for comparing inspection object data with reference data to perform a print inspection, said inspection object data acquired in a processing of print image data and said reference data representing an image condition as a reference for comparison with said inspection object data; and
b) an attribute information processing element for generating attribute information which is information on an attribute and layout information of an image element which is a constituent of said inspection object data or said reference data, and
said print inspection apparatus performing said print inspection selectively for each area with one attribute of said image element in said inspection object data or said reference data.

13. The print inspection apparatus according to claim 12, wherein
said attribute information processing element comprises
b-1) a coordinate transformation element for transforming a coordinate value of a predetermined initial attribute information into a coordinate value suitable for said inspection object data, to generate said attribute information.

14. The print inspection apparatus according to claim 13, further comprising
c) a print inspection parameter setting element for setting a predetermined print inspection parameter to be used in a print inspection operation, said print inspection parameter being set for said each area.

15. The print inspection apparatus according to claim 14, wherein
said print inspection parameter setting element sets said print inspection parameter on said each area on the basis of said attribute information.

16. The print inspection apparatus according to claim 15, further comprising
d) a print inspection parameter database for storing said print inspection parameter in advance.

17. A print inspection apparatus comprising:
a) a comparison element for comparing inspection object data with reference data to perform a print inspection, said inspection object data acquired in a processing of print image data and said reference data representing an image condition as a reference for comparison with said inspection object data;
b) a feature extraction element for extracting a feature of a print inspection result; and
c) a classification element for classifying said print inspection result on the basis of said feature.

18. The print inspection apparatus according to claim 17, wherein
said feature extraction element comprises at least one of
b-1) a differential image feature extraction element for extracting a feature of a differential area appearing in a differential image which is represented by differential image data obtained as said print inspection result;
b-2) a reference image feature extraction element for extracting an image feature of an area in said reference data corresponding to said differential area; and
b-3) a setting dependence feature extraction element for extracting a feature of said print inspection result which depends on setting of a processing condition in said print inspection.

19. The print inspection apparatus according to claim 18, further comprising
d) a preview image generation element for generating preview image data on the basis of a classification result obtained by said classification element, said preview image data being image data used for being displayed on a predetermined display means so that a feature of said print inspection result can be visually identified in accordance with its content.

20. The print inspection apparatus according to claim 19, further comprising
e) a classification result database for storing said classification result obtained by said classification element.

21. A method of inspecting print data, comprising the steps of:
a) performing a rasterization processing of layout data to obtain output image data;
b) comparing inspection object data with reference data to perform a print inspection, said inspection object data being said output image data or image data acquired in a processing of said output image data and said reference data representing an image as a reference for comparison with said inspection object data;
c) generating first attribute information containing an attribute and layout information of an object which is a constituent of said layout data; and
d) generating second attribute information on the basis of said first attribute information, said second attribute information being information on an attribute and layout information of an image element which is a constituent of said inspection object data or said reference data,
wherein said print inspection is performed selectively for each area with one attribute of said image element in said inspection object data or said reference data in said step b).

22. The method according to claim 21, wherein
said step c) includes the step of
c-1) transforming a coordinate value of said first attribute information into a coordinate value suitable for said inspection object data, to generate said second attribute information.

23. The method according to claim 22, further comprising the step of
e) setting a predetermined print inspection parameter to be used in a print inspection operation, said print inspection parameter being set for said each area.

24. The method according to claim 23, wherein
said print inspection parameter on said each area is set on the basis of said second attribute information in said step e).

25. The method according to claim 24, wherein
said print inspection parameter is stored in a predetermined print inspection parameter database in advance.

26. A method of classifying a print inspection result which is obtained by print inspection through comparison between inspection object data and reference data, comprising the steps of:
a) extracting a feature of a print inspection result; and
b) classifying said print inspection result on the basis of said feature,
wherein said inspection object data is acquired in a processing of print image data and said reference data represents an image as a reference for comparison with said inspection object data.

27. The method according to claim 26, wherein
said step a) includes at least one of the steps of
a-1) extracting a feature of a differential area appearing in a differential image which is represented by differential image data obtained as said print inspection result;
a-2) extracting an image feature of an area in said reference data corresponding to said differential area; and
a-3) extracting a feature of said print inspection result which depends on setting of a processing condition in said print inspection.

28. A program which is executed by a computer to cause said computer to function as an attribute information generation apparatus comprising:
a) a layout data acquisition element for acquiring layout data; and
b) an attribute information generation element for generating attribute information containing an attribute and layout information of an object which is a constituent of said layout data.

29. A program which is executed by a computer to cause said computer to function as a rasterization processing apparatus comprising:
a) a rasterization processing element for performing a rasterization processing of layout data to generate output image data; and
b) an attribute information generation element for generating attribute information containing an attribute and layout information of an object which is a constituent of said layout data.

30. A program which is executed by a computer to cause said computer to function as a print inspection apparatus comprising:
a) a comparison element for comparing inspection object data with reference data to perform a print inspection, said inspection object data acquired in a processing of print image data and said reference data representing an image condition as a reference for comparison with said inspection object data; and
b) an attribute information processing element for generating attribute information on an attribute and layout information of an image element which is a constituent of said inspection object data or said reference data,
wherein said print inspection apparatus performs said print inspection selectively for each area with one attribute of said image element in said inspection object data or said reference data.

31. A program which is executed by a computer to cause said computer to function as a print inspection apparatus comprising:
a comparison element for comparing inspection object data with reference data to perform a print inspection, said inspection object data acquired in a processing of print image data and said reference data representing an image condition as a reference for comparison with said inspection object data;
a feature extraction element for extracting a feature of a print inspection result; and
a classification element for classifying said print inspection result on the basis of said feature.
